(19) United States
(12) Patent Application Publication
(10) Pub. No.: US 2014/0028189 A1
(43) Pub. Date: Jan. 30, 2014

(54) Architectures for LED Lighting Assemblies

(71) Applicant: B/E AEROSPACE, INC., Wellington, FL (US)

(72) Inventors: David P. Eckel, Fort Salonga, NY (US); Eric Johannessen, Bohemia, NY (US); Gannon T. Gambeski, Saint James, NY (US)

(21) Appl. No.: 13/909,195

(22) Filed: Jun. 4, 2013

Related U.S. Application Data
(60) Provisional application No. 61/676,009, filed on Jul. 26, 2012.

(51) Int. Cl. H05B 37/02

(52) U.S. Cl. CPC H05B 37/02
USPC 315/85; 315/87

(57) ABSTRACT

A modular light emitting diode (LED), remote phosphor, and other lighting technologies lighting assembly includes a plurality of lighting subassemblies and a power supply electrically coupled with the plurality of lighting subassemblies in parallel such that each of the plurality of lighting subassemblies receives electrical power from the power supply in parallel with the other of the plurality of lighting subassemblies.

### CROSS REFERENCE TO RELATED APPLICATIONS

The present application claims the benefit of U.S. Provisional Application No. 61/676,009, filed Jul. 26, 2012, entitled, “Architectures for Led Lighting Assemblies”, herein incorporated by reference.

### BACKGROUND

Embodiments disclosed herein relate to LED cabin lighting architectures, and more specifically to power distribution for LED cabin lighting architectures and configurations.

Multi-color LED lighting systems for cabin lighting in vehicles such as aircraft typically include multiple LED lighting elements, each of which emit light at a different wavelength, such that a wide range of different colors may be represented. In one such system, there may be three separate assemblies, each of which include LEDs that emit light at a different wavelength from the other separate assemblies, and there may be different lighting technologies as well. Typically, each of these assemblies would include a separate power supply to power the LED lighting elements within the respective assembly.

### SUMMARY

The following acronyms are used herein.

TABLE OF ACRONYMS

| | |
|---|---|
| AC | alternating current |
| ACP | attendant control panel |
| CAN bus | controller area network bus |
| DC | direct current |
| EMI | electromagnetic interference |
| HMI | human machine interface |
| LCU | lighting control unit |
| LED | light emitting diode |
| PFC | power factor controller |
| PIM | PWM interface module |
| PWM | pulse width modulation |
| VAC | volts alternating current |
| VDC | volts direct current |
| ZMU | zone management unit |

According to an embodiment, a modular light emitting diode (LED) lighting assembly includes a plurality of LED lighting subassemblies and a power supply electrically coupled with the plurality of LED lighting subassemblies in parallel such that each of the plurality of LED lighting subassemblies receives electrical power from the power supply in parallel with the other of the plurality of LED lighting subassemblies.

According to another embodiment, a method of powering a modular light emitting diode (LED) lighting assembly includes converting input alternating current (AC) electrical power into direct current (DC) electrical power, and supplying the converted DC electrical power to a plurality of LED lighting subassemblies in parallel with one another.

### BRIEF DESCRIPTION OF THE DRAWINGS

Exemplary embodiments will be explained in more detail with reference to the attached drawings in which the embodiments are illustrated as briefly described below:

FIG. 1 is a block diagram illustrating an LED cabin lighting assembly having a distributed power architecture in which multiple LED cabin lighting subassemblies are powered using a single power supply, according to an embodiment;

FIG. 2A is a block diagram illustrating an exemplary galley light configuration with separate galley and insert/appliance power and control;

FIG. 2B is a block diagram illustrating another exemplary galley light configuration with separate galley and insert/appliance power and control;

FIG. 3 is a block diagram illustrating an exemplary galley light configuration with a common galley and insert power and control;

FIG. 4 is a block diagram illustrating a relationship between the inserts and the human-machine interfaces (HMI);

FIG. 5 is a block diagram illustrating the CAN bus from the galley system supplying various lights;

FIG. 6A is a block diagram including a zone management unit or light control unit and the attendant control panel; and

FIG. 6B is a block diagram is another embodiment including a zone management unit or light control unit and the attendant control panel.

### DETAILED DESCRIPTION

As used herein, an assembly refers to a collection of components assembled together as a single unit. The assembly may be defined as contained within a single housing, electrically interconnected with one another in close proximity, physically interconnected with one another in close proximity, or otherwise assembled together as a group in such manner as one of ordinary skill in the art would consider the collection of components to be a single unit. A subassembly may be defined as an assembly in its own right which is also a constituent component of another assembly. Thus, in various embodiments, an assembly in one context may also be considered a subassembly in another context, and vice-versa.

If an LED cabin lighting system has multiple LED lighting elements, assemblies, or subassemblies where each LED lighting element, subassembly, or assembly has its own power supply, a corresponding excess of cost and weight and decrease in efficiency can result. For example, in an alternate design of a multi-color LED cabin lighting system where there are three LED assemblies, each of which emits light at a different wavelength, each of the LED assemblies might also include a separate power supply.

In various embodiments, cost and weight of the LED cabin lighting system can be decreased while efficiency is increased by decreasing the number of power supplies without decreasing the number of LED lighting elements. This may be accomplished by a modular LED cabin lighting architecture in which multiple LED lighting elements are arranged in multiple separate LED lighting subassemblies within a single LED lighting assembly, and the multiple LED lighting subassemblies are powered using a single power supply in the LED lighting assembly.

In various embodiments, a plurality of LED cabin lighting subassemblies may be powered using a single power supply. For example, in an embodiment, all LED cabin lighting assemblies of a large LED cabin lighting system may be powered by a single power supply. However, for a large LED cabin lighting system with many LED cabin lighting assemblies, this approach may not be efficient, because of the size of the power supply required and the length of the power lines running from the shared power supply to all the individual LED cabin lighting assemblies. These inefficiencies may result in a disadvantageous weight and cost of the overall system. A single large power supply may require heavy, high current wires to be run in order to power the system. Such wire runs would increase the system's weight and cost. In addition, it may be challenging to place the single large power supply in an optimal location to efficiently power the large LED cabin lighting system, since the LED cabin lighting assemblies may be spread throughout a large aircraft cabin.

In another embodiment, a single power supply may power a plurality of LED cabin lighting subassemblies that are located in close proximity to one another. In this embodiment, a second plurality of LED cabin lighting subassemblies that is located some distance away from the first plurality of LED cabin lighting subassemblies may be powered by a second single power supply that is different from the first single power supply. The plurality of LED cabin lighting subassemblies that are located in close proximity to one another may emit light at different wavelengths from one another, such that the plurality of LED cabin lighting subassemblies combined with the single power supply form a complete multi-color LED cabin lighting assembly. This architecture may facilitate straightforward optimization of the cost, weight, and efficiency tradeoffs of using multiple power supplies in a large LED cabin lighting system. A multi-color LED cabin lighting assembly according to an embodiment in which a single power supply provides power to multiple LED cabin lighting subassemblies or LED elements reduces a total number of components and leads to better reliability than prior LED cabin lighting systems where each LED cabin lighting assembly had a separate power supply. In addition, the embodiment in which a single power supply provides power to multiple LED cabin lighting subassemblies may be more straightforward to optimize for performance, weight, and cost.

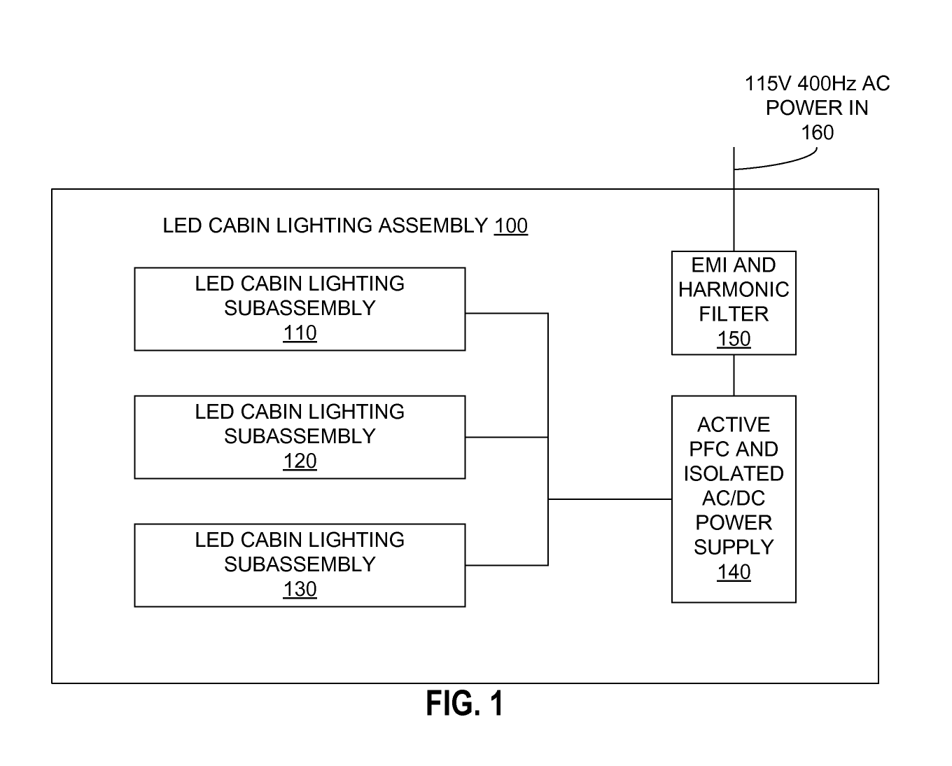

FIG. 1 illustrates an LED cabin lighting assembly 100 having a distributed power architecture in which multiple LED cabin lighting subassemblies are powered using a single power supply, according to an embodiment. In an embodiment, a full LED cabin lighting system includes plurality of LED cabin lighting assemblies 100 spaced apart in different locations of an aircraft cabin.

The LED cabin lighting assembly 100 includes an LED cabin lighting subassembly 110, an LED cabin lighting subassembly 120, and an LED cabin lighting subassembly 130. Each of the LED cabin lighting subassemblies 110, 120, and 130 may be substantially the same except that they may each emit light at a different wavelength from the others, or incorporate different lighting technology types. These different lighting technology types can include remote phosphor in which phosphor is bonded to a substrate instead of incorporating it into the LED die package (LEDs and LED lighting, as used herein, should also be understood to include remote phosphor lighting). These different lighting technology types can also include fluorescent, incandescent, electroluminescent, and other forms of lighting. Although LED lighting is described in an embodiment herein, it should be understood that this is an instance of a more generalized concept for other lighting technology types as well, which could be substituted in place of LED lighting, where possible.

The LED cabin lighting subassemblies 110, 120, and 130 may each include an electronic circuit board having one or more LED lighting elements and associated driver electronics. The LED cabin lighting subassemblies 110, 120, and 130 may all receive power from a common active power factor controller (PFC) and isolated AC/DC power supply 140. The LED cabin lighting subassemblies 110, 120, and 130 may be coupled in parallel with the power supply 140 via a common power bus as illustrated. Alternatively, each of the LED cabin lighting subassemblies 110, 120, and 130 may be coupled with the power supply 140 via individual power supply lines.

The power supply 140 may convert input alternating current (AC) power into output direct current (DC) power. For example, the power supply 140 may receive 115 volt (V) AC power at a frequency of 400 Hertz (Hz) and output power at a lower DC voltage. The power supply 140 may control the amount of power drawn by the LED cabin lighting subassemblies 110, 120, and 130 by controlling the shape and magnitude of the electrical current waveform supplied to the LED cabin lighting subassemblies 110, 120, and 130 in relation to the input AC waveform received by the power supply 140.

The power supply 140 may receive input AC power via an electromagnetic interference (EMI) and harmonic filter 150. The EMI and harmonic filter 150 may be coupled with an input power source 160, such as an AC power supply onboard an aircraft which supplies 115V 400 Hz AC power. The EMI and harmonic filter 150 may include electronic filter elements such as any of resistors, capacitors, and inductors to filter out unwanted harmonic frequencies and electromagnetic interference present on the input power source 160.

Including multiple LED cabin lighting subassemblies 110, 120, and 130 in the LED cabin lighting assembly 100 as opposed to only a single, larger, all-inclusive LED lighting cabin lighting subassembly provides a number of benefits. For example, each of the LED lighting cabin lighting subassemblies 110, 120, and 130 may be smaller and lower cost than a larger all-inclusive LED lighting cabin lighting subassembly. Therefore, should an LED or associated driver component of an LED cabin lighting subassembly 110, 120, or 130 fail and need to be replaced, the replacement would be more easily and inexpensively performed than if all the constituent components of the LED cabin lighting subassemblies 110, 120, and 130 were integrated into a single LED cabin lighting subassembly or integrated into the LED cabin lighting assembly 100 without a separate subassembly. Integrating all the LED lighting elements and driver circuits of the LED cabin lighting subassemblies 110, 120, and 130 into a single LED cabin lighting subassembly would also be more difficult, leading to higher cost than the illustrated solution of three LED cabin lighting subassemblies 110, 120, and 130.

For example, according to the embodiment illustrated in FIG. 1, the entire LED cabin lighting assembly 100 would not need to be replaced if an LED or driver circuitry of one of the LED cabin lighting subassemblies 110, 120, and 130 fails. If a white LED element fails, because the white element may be used the most out of all the different color LEDs in an LED cabin lighting system, only the LED cabin lighting subassembly including the white LED would need to be replaced, and not the entire LED cabin lighting assembly 100. Thus, the architecture of the LED cabin lighting assembly 100 illustrated in FIG. 1 provides modularity and interchangeability between components of the overall LED cabin lighting system to lower the total cost of ownership by increasing efficiency, reducing spare parts inventory costs, and reducing maintenance costs. The lighting subassemblies are preferably readily removably mounted within the lighting assembly. Such removable mountings include plug-in technology such as a plug or a card-edge connector into a mating socket.

By combining the multiple LED cabin lighting subassemblies 110, 120, and 130 with a single power supply 140 within the LED cabin lighting assembly 100 in the embodiment illustrated in FIG. 1, the desired output illumination of the LED cabin lighting assembly 100 is more efficiently achieved without the additional costs, weight, and reliability issues of having a separate power supply for each of the LED cabin lighting subassemblies 110, 120, and 130. The illustrated embodiment has a reduced part count and increased efficiency and reliability compared to an alternative solution having a separate power supply for each of the LED cabin lighting subassemblies 110, 120, and 130.

In various embodiments, any number of LED elements may be combined within a single LED cabin lighting subassembly. For example, two, three, four, five, six, seven, eight, nine, ten, or more LED lighting elements may be combined within a single LED cabin lighting subassembly. Likewise, any number of LED cabin lighting subassemblies may be combined within a single LED cabin lighting assembly. For example, two, three, four, five, six, seven, eight, nine, ten, or more LED cabin lighting subassemblies may be combined within a single LED cabin lighting assembly. In addition, any number of LED cabin lighting assemblies may be combined together into a single LED cabin lighting system. For example, two, three, four, five, six, seven, eight, nine, ten, or more LED cabin lighting assemblies may be combined within a single LED cabin lighting system. The LED cabin lighting assemblies may be used as wash lights, reading lights, or other types of lights onboard a vehicle.

In various embodiments, optical filters may be included in the LED cabin lighting assembly 100 or any of the LED cabin lighting subassemblies 110, 120, and 130. The optical filters may be used to adjust the color and amount of light emanating from the LED cabin lighting assembly 100 or any of the LED cabin lighting subassemblies 110, 120, and 130. In various embodiments, the optical filters may be provided exterior to the LED cabin lighting assembly 100 or any of the LED cabin lighting subassemblies 110, 120, and 130, for example, separate and external to the enclosures of the LED cabin lighting assembly 100 or any of the LED cabin lighting subassemblies 110, 120, and 130.

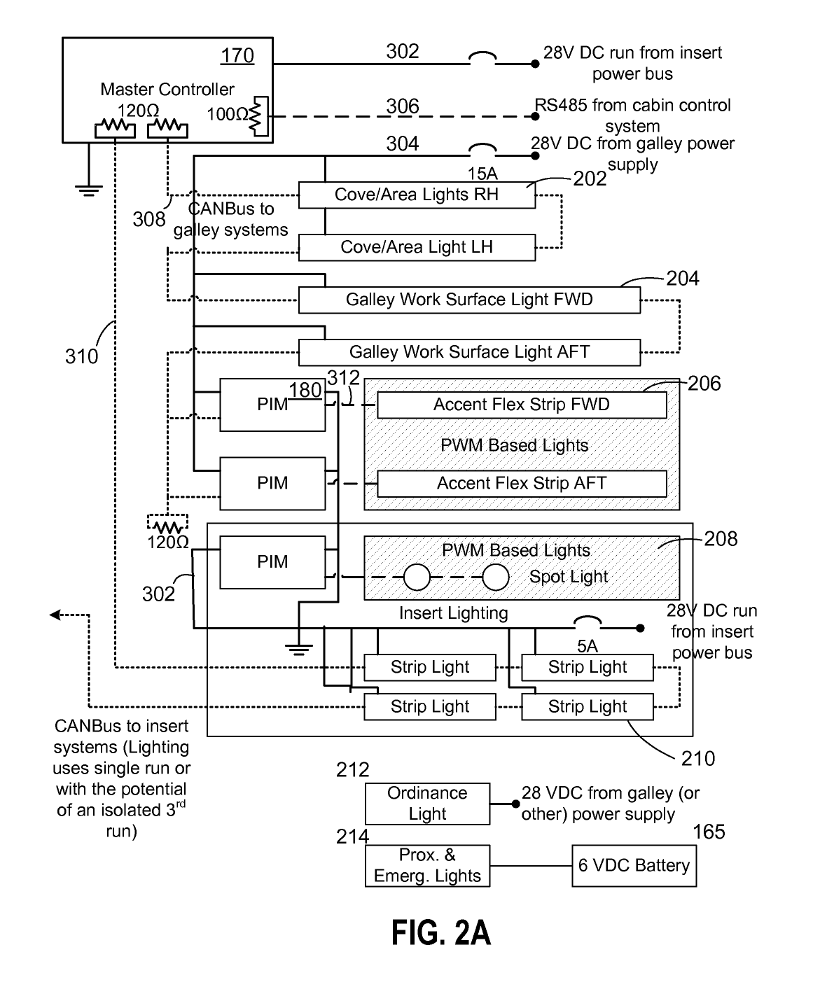

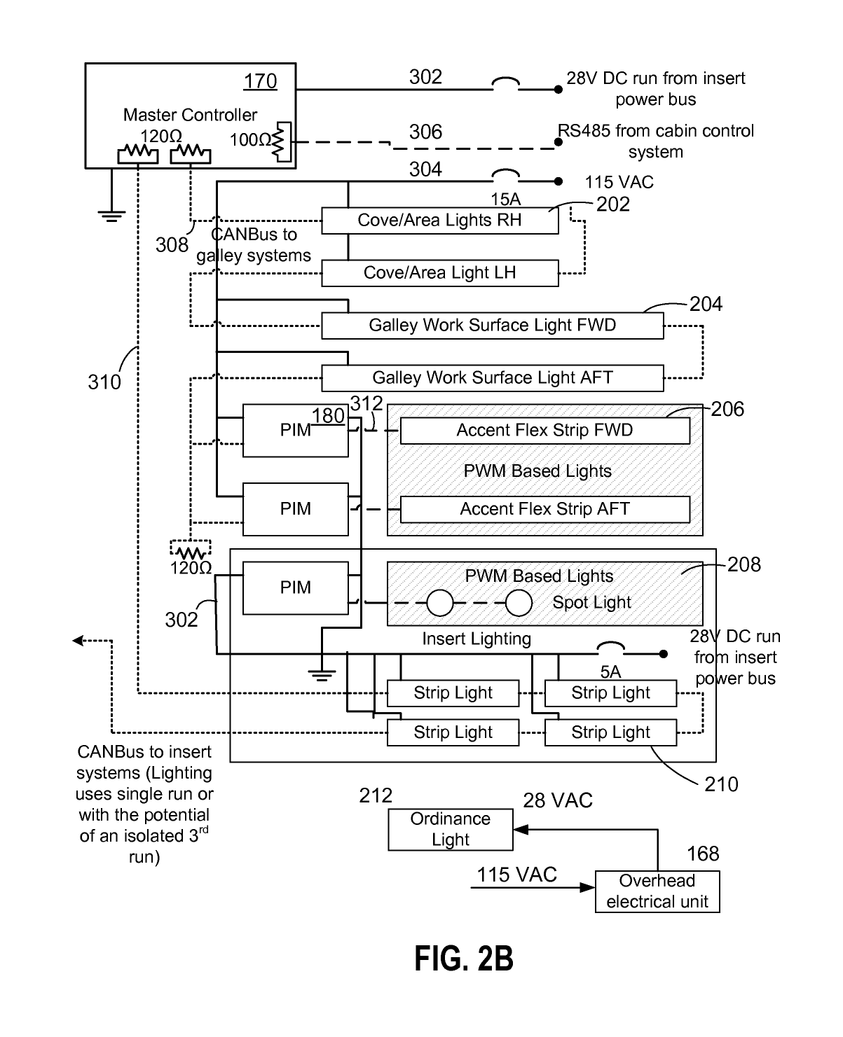

FIG. 2A illustrates an exemplary lighting system architecture which uses a separate galley and insert/appliance power and control. A master controller 170 received power and control information: 28 VDC from an insert power bus 302, and high-level communications from a cabin control system on a communications bus 306, such as RS 485. The high level communications might be to set lighting to a particular scene (the scene being associated with one or more particular color points associated with each light—a given scene may have several different color points associated with different lights). The master controller 170 can control a number of different aspects, including power management and allocating a power budget—not just for the lighting, but also with regard to other inserts, such as heating and cooling units.

The control system can communicate with intelligent lighting modules/subassemblies in the system in addition to controlling power to the lights and other vehicle units. For unintelligent lighting modules/subassemblies, a small front-end control unit may be provided.

In an embodiment, the CAN Bus 308, 310 is used to communicate with the lighting systems and to other insert systems. The CAN Bus is preferable since it contains within it a way of prioritizing communications so that more demanding devices get a greater bandwidth and higher priority. It can engage in arbitration and priority-based communications. In FIG. 2A, some of the lights, such as the cove/area lights 202, the galley work surface lights 204, and the strip lights 210 are “smart” light modules in that they can receive high-level communications from the master controller and do so directly over the CAN Bus 308, 310. However, other “dumb” light modules, such as the accent flex strip 206 and the spot light 208 are only able to directly input pulse-width modulation (PWM) signals, and thus need a front end that can translate higher level (e.g., color point, or scene instructions) into respective PWM signals.

In order to achieve this, a PWM interface module (PIM) 180 may be provided. This PIM 180 may take the high level CAN Bus signals and convert them into the low level PWM signals needed by the dumb light modules. In an embodiment, the PIM 180 has dimensions on the order of 1″×2″×0.5″, and may have a card edge connector so that it interfaces cleanly with the respective light module and can even appear to be a part of the light module itself. The PIMs 180 may comprise a wireless interface, such as Bluetooth or Wi-Fi, and the CAN Bus can be implemented wirelessly as well.

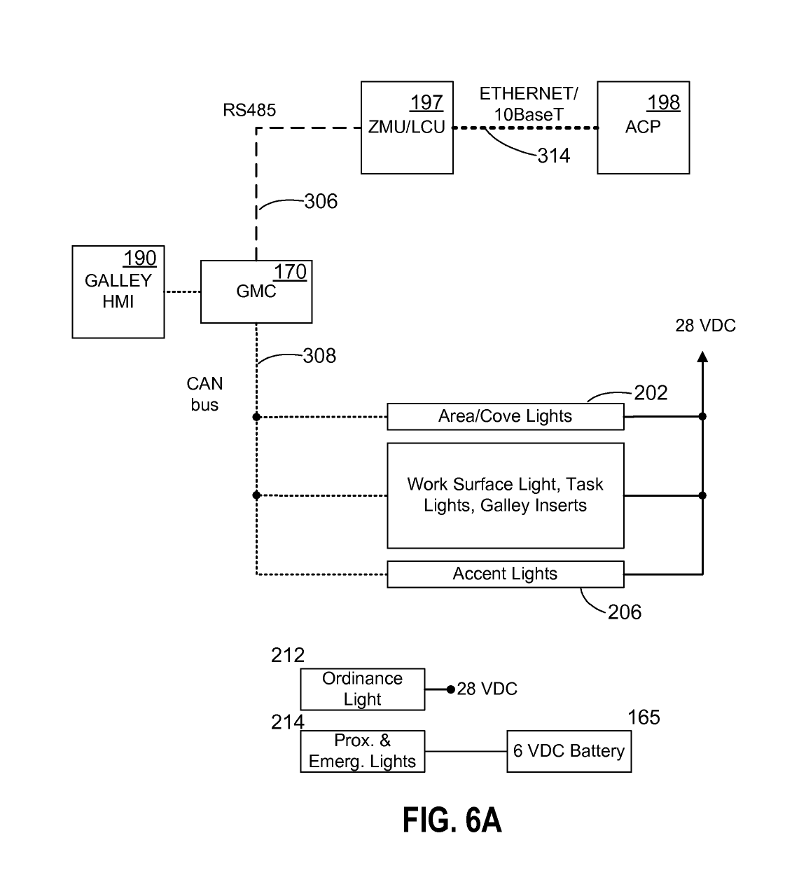

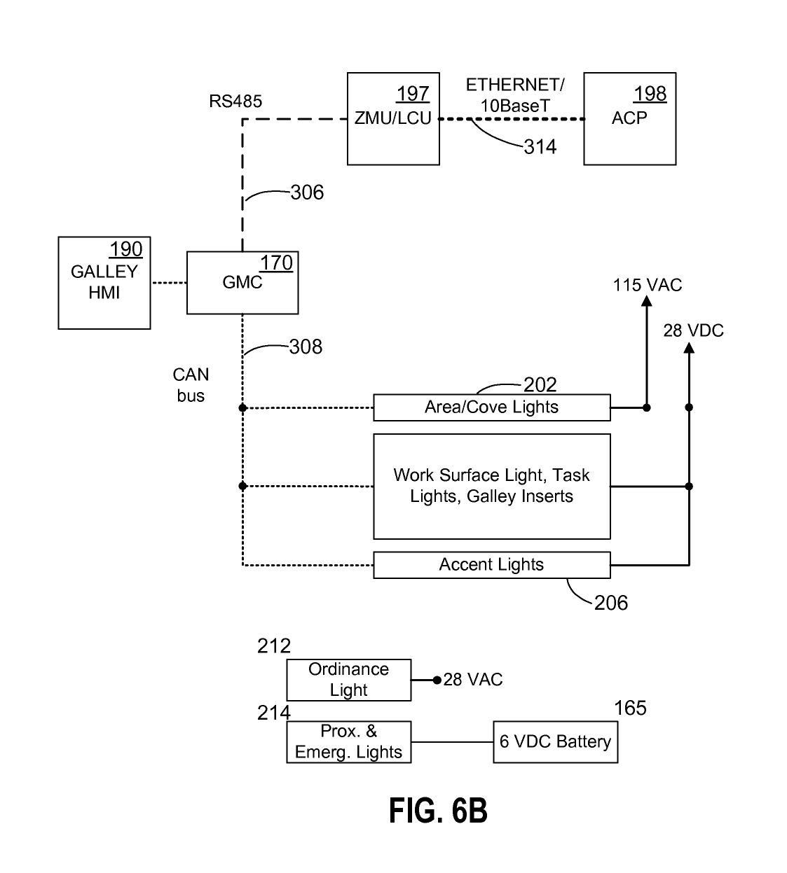

Insert lights 210′ may be combined as one CAN Bus address and dimmed together. Cove/area lights 202 and galley work surface lights 204 can be addressed as a scene on CAN Bus. The master controller 170 can receive RS485 from an existing attendant control panel (ACP) 198 (FIG. 6) and configure the lights accordingly. Upon receiving a dim command, the power provided to the lights associated with the address to which the dim command is directed can be reduced. Control for various lighting functions, such as accent lighting control, can be provided locally via the HMI. Accent lighting 206 may be tied into the ACP 198 as well. Power management and load sharing with all systems is handled by master controller 170 and possibly other hardware/software. Local HMI control may dim galley task 204 and cove/area 202 lighting with the ACP.

Also shown in FIG. 2A are ordinance lights 212 that may be powered by 28 VDC from galley (or other) power supply. The ordinance lights 212 include indication lights such as “Return to Seat”, “Lavatory Occupied”, “No Smoking”, “Fasten Seat Belt”, “WiFi On/Off”, etc. Also, proximity and emergency lights 214, including exit signs, etc. may be powered by a battery, such as the 6 VDC battery 165 shown in FIG. 2A. The battery can be recharged by the 115 VAC of the vehicle.

FIG. 2B primarily replicates FIG. 2A, with the exception that the cover/area lights 202 can be powered from the aircraft 115 VAC. Also, the ordinance lights 212 can be powered by 28 VAC via an overhead electrical unit 168 that converts the vehicle 115 VAC into 28 VAC.

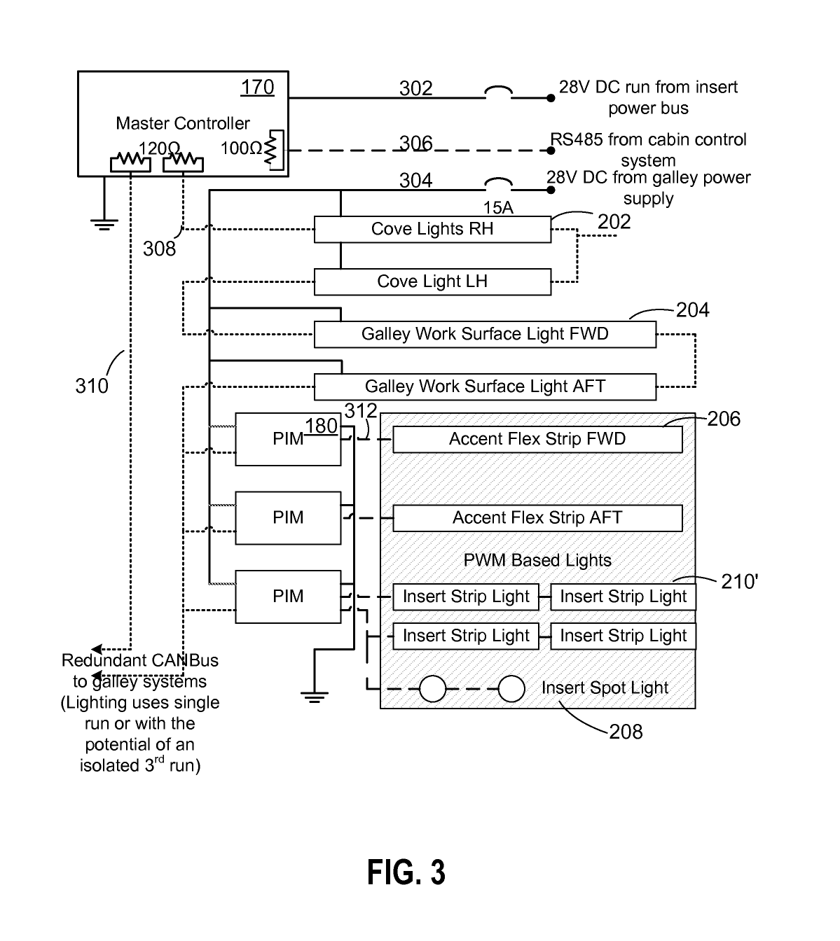

FIG. 3 shows a similar system. However, the primary difference is that FIG. 3 shows a common galley and insert power and control.

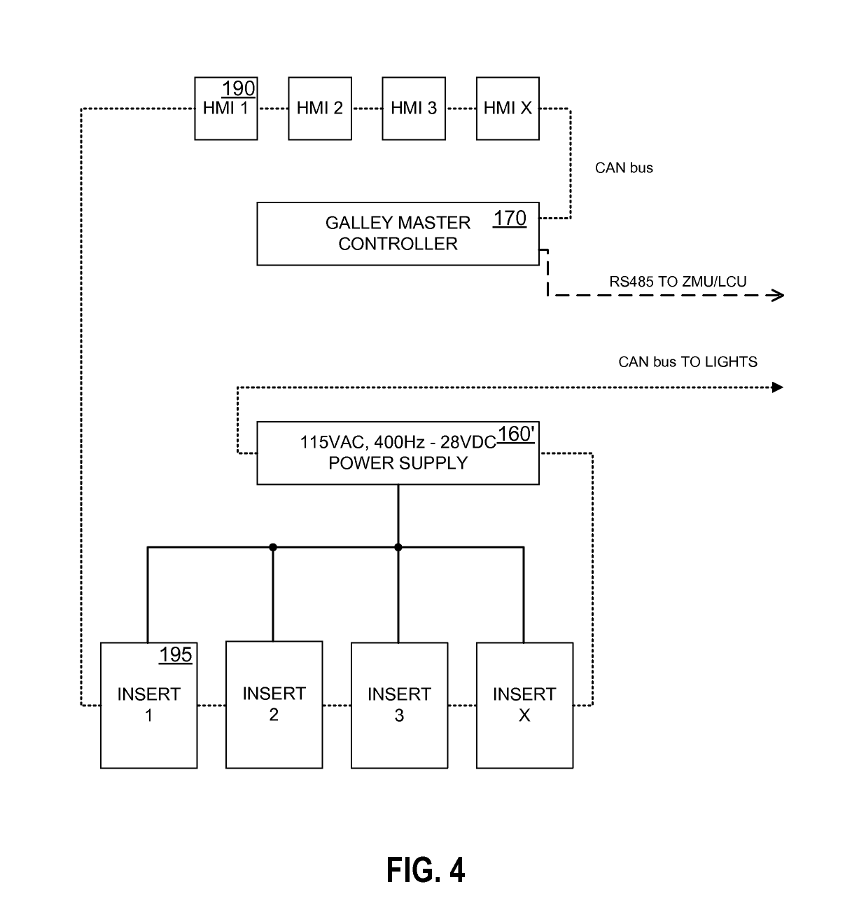

FIG. 4 shows the relationship between the inserts 195 themselves, and human machine interfaces (HMIs) 190. In an embodiment, an HMI 190 is positioned proximate the particular insert 195 so that the insert 195 can be controlled. However, there does not need to be a 1:1 logical correlation. In other words, although HMI 1 may be physically located proximate insert 1 195, it may be able to access and control other inserts as well—HMI 1 190 could be used to control insert x 195. FIG. 4 also shows the possible use of both a 115 VAC 400 Hz and 28 VDC power supply to power the inserts.

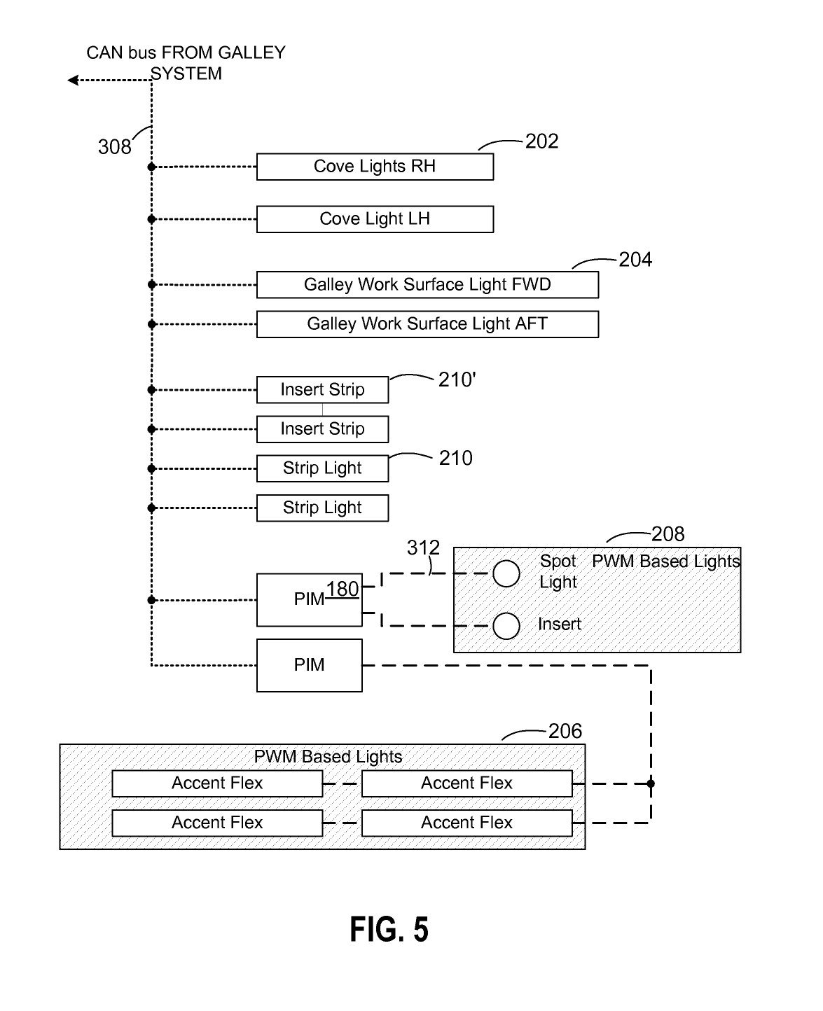

In FIG. 5, the CAN Bus from FIG. 4 the connected the HMIs 190 and inserts 195 can also be the interface 308 connecting all of the lights together, with direct connections to the smart lights 202, 204, 210, 210′ as well as the PWM-based (dumb) lights 206, 208.

Finally, FIG. 6A shows the inclusion of an attendant control panel 198 which can be used to control the overall lighting and other inserts in the galley. It may be connected to a zone management/lighting control unit (ZMU/LCU) 197 via a network interface 314, such as Ethernet/10BaseT. The ZMU/LCU 197 may then communicate with the master controller 170 via RS 485 306.

The power may be provided to the galley in a number of different configurations. In a hybrid configuration, a single power supply may be used to power the lighting in the galley at 28 VDC, whereas some or all of the inserts are powered at 115 VAC or 270 VDC. There may be a switch, either hardware or software, that can change a given light unit between 28 VDC and 115 VAC. This single power supply could be connected to the CAN Bus which could report back various aspects of power usage. In one variation, each lighting unit or PIM has its own small power supply associated with it to perform the conversion. In another embodiment, the entire galley, including lights and inserts, runs from a large power supply at 28 VDC.

FIG. 6B is a variation in which the ordinance lights 212 are provided with 28 VAC, and the area/cove lights 202 are provided with 115 VAC.

The LED loads may be provided in a same/common housing/lighting element or could be represented by separate lighting elements. Furthermore, the lighting loads can be synchronized to represent the same color point and intensity all at the same time or to be a part of a same cohesive scene or lighting scheme even though individuals lighting units or LED loads are different. Alternately, the individual lighting units or LED loads can be set to unrelated color points and/or intensity. Any given lighting unit could house LEDs of one color, or could house multi-color LEDs, including RGB, RGBW, RGBY, RGBWY, RBW, WWA, WWR, and those that use remote phosphor technology.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the embodiments illustrated in the drawings, and specific language has been used to describe these embodiments. However, no limitation of the scope of the invention is intended by this specific language, and the invention should be construed to encompass all embodiments that would normally occur to one of ordinary skill in the art. The terminology used herein is for the purpose of describing the particular embodiments and is not intended to be limiting of exemplary embodiments of the invention. In the description of the embodiments, certain detailed explanations of related art are omitted when it is deemed that they may unnecessarily obscure the essence of the invention.

The apparatus described herein may comprise a processor, a memory for storing program data to be executed by the processor, a permanent storage such as a disk drive, a communications port for handling communications with external devices, and user interface devices, including a display, touch panel, keys, buttons, etc. When software modules are involved, these software modules may be stored as program instructions or computer readable code executable by the processor on a non-transitory computer-readable media such as magnetic storage media (e.g., magnetic tapes, hard disks, floppy disks), optical recording media (e.g., CD-ROMs, Digital Versatile Discs (DVDs), etc.), and solid state memory (e.g., random-access memory (RAM), read-only memory (ROM), static random-access memory (SRAM), electrically erasable programmable read-only memory (EEPROM), flash memory, thumb drives, etc.). The computer readable recording media may also be distributed over network coupled computer systems so that the computer readable code is stored and executed in a distributed fashion. This computer readable recording media may be read by the computer, stored in the memory, and executed by the processor.

Also, using the disclosure herein, programmers of ordinary skill in the art to which the invention pertains may easily implement functional programs, codes, and code segments for making and using the invention.

The invention may be described in terms of functional block components and various processing steps. Such functional blocks may be realized by any number of hardware and/or software components configured to perform the specified functions. For example, the invention may employ various integrated circuit components, e.g., memory elements, processing elements, logic elements, look-up tables, and the like, which may carry out a variety of functions under the control of one or more microprocessors or other control devices. Similarly, where the elements of the invention are implemented using software programming or software elements, the invention may be implemented with any programming or scripting language such as C, C++, JAVA®, assembler, or the like, with the various algorithms being implemented with any combination of data structures, objects, processes, routines or other programming elements. Functional aspects may be implemented in algorithms that execute on one or more processors. Furthermore, the invention may employ any number of conventional techniques for electronics configuration, signal processing and/or control, data processing and the like. Finally, the steps of all methods described herein may be performed in any suitable order unless otherwise indicated herein or otherwise clearly contradicted by context.

For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. The words “mechanism”, “element”, “unit”, “structure”, “means”, and “construction” are used broadly and are not limited to mechanical or physical embodiments, but may include software routines in conjunction with processors, etc.

The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those of ordinary skill in this art without departing from the spirit and scope of the invention as defined by the following claims. Therefore, the scope of the invention is defined not by the detailed description of the invention but by the following claims, and all differences within the scope will be construed as being included in the invention.

No item or component is essential to the practice of the invention unless the element is specifically described as “essential” or “critical”. It will also be recognized that the terms “comprises,” “comprising,” “includes,” “including,” “has,” and “having,” as used herein, are specifically intended to be read as open-ended terms of art. The use of the terms “a” and “an” and “the” and similar referents in the context of describing the invention (especially in the context of the following claims) are to be construed to cover both the singular and the plural, unless the context clearly indicates otherwise. In addition, it should be understood that although the terms “first,” “second,” etc. may be used herein to describe various elements, these elements should not be limited by these terms, which are only used to distinguish one element from another. Furthermore, recitation of ranges of values herein are merely intended to serve as a shorthand method of referring individually to each separate value falling within the range, unless otherwise indicated herein, and each separate value is incorporated into the specification as if it were individually recited herein.

TABLE OF REFERENCE CHARACTERS

| | |
|---|---|
| 100 | LED cabin lighting assembly |
| 110, 120, | LED cabin lighting subassembly |
| 130 | |
| 140 | active PFC and Isolated AC/DC power supply |
| 150 | EMI and harmonic filter |
| 160 | 115 VAC 400 Hz power in |
| 160′ | dual 115 VAC 400-28 VDC power supply |
| 165 | battery |
| 168 | overhead electrical unit |
| 170 | master controller |
| 180 | pulse width modulation (PWM) interface module (PIM) |
| 190 | human-machine interface |
| 195 | insert |
| 197 | zone management unit (ZMU)/light control unit (LCU) |
| 198 | attendant control panel ACP |
| 2xx | light types |
| 202 | cove lights |
| 204 | galley work surface light |
| 206 | accent flex strip |
| 208 | insert spot light |
| 210 | strip light |
| 210′ | insert strip light |
| 212 | ordinance light |
| 214 | proximity & emergency lights |
| 3xx | power and communication lines |
| 302 | 28 VDC run from insert power bus |
| 304 | 28 VDC from galley power supply |
| 306 | RS 485 from cabin control system |
| 308 | CAN Bus to galley systems |
| 310 | CAN Bus to insert systems |
| 312 | PWM line |
| 314 | Ethernet 10BaseT |

What is claimed is:

1. A modular lighting assembly, comprising:
a first lighting subassembly, comprising:
a plurality of light elements of a first type or that produce light of a first wavelength;
a connector for removably mounting the first subassembly to the assembly; and
a power input at which power is received for illuminating the light elements of the first lighting subassembly;
a second lighting subassembly separated from the first lighting subassembly, comprising:
a plurality of light elements of a second type that is different from the first type or that produce light of a second wavelength that is different from the first wavelength;
a connector for removably mounting the second subassembly to the assembly; and
a power input at which power is received for illuminating the light elements of the second lighting subassembly;
a single power supply that is connected to the power input of the first lighting subassembly and provides power to the first lighting subassembly, and is connected to the power input of the second lighting subassembly and provides power to the second lighting subassembly.

2. The lighting assembly of claim 1, further comprising an electromagnetic interference and harmonic filter connected to an input of the power supply.

3. The lighting assembly of claim 1, wherein the connectors of the first and second lighting subassemblies are plug and socket or card edge and socket connectors.

4. The lighting assembly of claim 1, wherein the lighting assembly is a light emitting diode (LED) aircraft cabin lighting assembly.

5. The lighting assembly of claim 1, wherein the first and second type of light elements are different types, and are each selected from the group consisting of LED, remote phosphor, and fluorescent.

6. The lighting assembly of claim 1, wherein the first and second type of light elements are different wavelengths, and are each selected from the group consisting of red, green, blue, white, yellow, and amber.

7. The lighting assembly of claim 1, wherein the first lighting subassembly is a cove or area light, and the power input is a 28 VDC input.

8. The lighting assembly of claim 1, wherein the first lighting subassembly is a cover or area light, and the power input is a 115 VAC input.

9. The lighting assembly of claim 1, wherein the first lighting subassembly is a cove or area light, and the power input is switchable between a DC and an AC input.

10. The lighting assembly of claim 9, wherein the switchable power input is a software switchable power input.

11. The lighting assembly of claim 1, wherein the first lighting subassembly and the second lighting subassembly share power lines provided at their power inputs.

12. The lighting assembly of claim 1, wherein the first lighting subassembly and the second lighting subassembly are at a same address and are controlled together.

13. The lighting assembly of claim 1, wherein the first lighting subassembly and the second lighting subassembly each comprise a controller input for controlling the respective lighting subassembly.

14. The lighting assembly of claim 13, wherein the controller input is a CAN bus interface.

15. The lighting assembly of claim 1, wherein at least one of the first lighting subassembly and the second lighting subassembly comprises a smart front-end component as a part of the subassembly that translates high level instructions into pulse width modulation signals.

16. The lighting assembly of claim 1, wherein the power supply includes a power factor controller.

17. A lighting system, comprising:
a first lighting assembly as claimed in claim 1;
a second lighting assembly as claimed in claim 1;
a master controller that controls the first and second lighting assemblies and the respective lighting subassemblies contained therein; and
a network bus that connects the first lighting assembly, the second lighting assembly, and the master controller.

18. The lighting system according to claim 17, wherein the master controller comprises:
an RS-485 input; and
a CAN bus output connecting the master controller at least one of the first lighting assembly and the second lighting assembly.

19. The lighting system according to claim 17, wherein the master controller controls power management and allocates a power budget for the first and second lighting assemblies.

20. The lighting system according to claim 17, further comprising:
proximity and emergency lights connected to a battery; and
an ordinance light.
